(19) United States
(12) Patent Application Publication
(10) Pub. No.: US 2004/0210489 A1
(43) Pub. Date: Oct. 21, 2004

(54) System and method for dynamic allocation of products to retailers

(75) Inventors: Wade Jackson, Everett, WA (US); Ken Frost, Redmond, WA (US); Kim Jones, Redmond, WA (US); Huh Joon, Redmond, WA (US)

Correspondence Address: NIXON & VANDERHYE, P.C., 1100 N. GLEBE ROAD, 8TH FLOOR, ARLINGTON, VA, 22201, US

(73) Assignee: Nintendo of America Inc., Redmond, WA

(21) Appl. No.: 10/628,555

(22) Filed: Jul. 29, 2003

Related U.S. Application Data
(60) Provisional application No. 60/419,517, filed on Oct. 21, 2002.

(51) Int. Cl. G06G 1/14

(52) U.S. Cl. 705/22

(57) ABSTRACT

A method and system of dynamically allocating products to retailers for sale to consumers. Product groups, account groups and allocation methods are defined by the sales administrator. The system summarizes analysis statistics, determines ad quantity, retrieves inventory data, calculates allocation and carry-over allocation. For a given interval throughout each day, the allocation system refreshes product availability measures and redistributes allocations based on product availability and allocation method. The sales administrator can make manual adjustments to system generated allocations. The sales administrator then loads the allocations into the order processing system.

### RELATED CASE

This application claims the benefit of U.S. Provisional Application Serial No. 60/419,517 entitled “System and Method for Dynamic Allocation of Products to Retailers,” filed Oct. 21, 2002, the entire content of which is incorporated by reference herein.

### TECHNICAL FIELD

The present invention generally relates to a method and system of distributing product to retailers for sale to consumers and, more particularly, to an automated tool for use by sales administrators for allocating product in an efficient and advantageous manner. The tool enables various allocation methods to be defined for various products or classes of products. Historical data is used to provide information to the sales administrators for use in making allocation decisions. The system enables dynamic allocations by taking into account a variety of information over time to assure that allocation goals are met.

### BACKGROUND AND SUMMARY OF THE INVENTION

One of the most important responsibilities of a sales administration department is managing the distribution of product. For example, sales administrators working for a product manufacturer have the important job of allocating product to the various retailers (or other parties) that offer the product for sale to the public. One exemplary environment where product allocation is particularly important is in the video game industry. Video game hardware and software is often in great demand when launched and afterwards. Retailers that sell video game products compete for the available supply of products from the manufacturers. The demand for such products typically is greater than the available supply. The sales administrators must manage these competing interests and make decisions about how much of the available product will be allocated to which retailers. The allocation decisions they make can effect relationships with the retailers and the quantities of product sold over time, as well as costs associated therewith.

It is preferable to allocate products to retailers such that the allocations are sold out by the retailers at approximately the same time, thereby avoiding a situation where one retailer still has a large supply when other retailers have run out of the product. Thus, the administrators look at what inventory is on-hand, what is coming in and then make manual determinations about product allocations. Numerous variables need to be taken into account in order to allocate product in an efficient and effective manner and to assure that the quantity of sales can be maximized over given time periods with minimum cost. For example, the particular quantity of a product that is available for allocation can vary over time due to, for instance, unexpected supply interruptions or the like. In addition, depending on the particular product that is available for allocation, the preferred allocation may differ. For example, hardware allocations may be different than software allocations. In addition, the particular type of software (e.g., type of game) may dictate a specific allocation as compared to other types of software. Thus, allocation decisions often must be made on a product-by-product basis. Experienced sales administrators can develop over time a certain level of skill in allocating products based on their past experiences with similar products. However, even experienced administrators can have a difficult time in allocating products in the most effective way due to the many variables and competing interest that they face in making these decisions. In addition, it is difficult, if not impossible, to manually take into account all of the available information on sales history and determine allocations that will result in all retailers being out of stock at approximately the same time. A bad allocations could result in one retailer have a lot of remaining product that cannot be sold, thereby resulting is significant costs and inconvenience in trying to redistribute the remaining inventory or having to mark-down the product to promote further sales. Effective allocations also have to take into account advertising campaigns that may be run by retailers that will effect demand for some period of time.

In one current sales administration system, product is allocated on a spreadsheet. Once the allocations are “published”, they are manually entered into a computer for use and reporting purposes. Throughout the weeks and months of a product cycle, allocations may be increased, decreased or not taken by the retailer, which leaves unclaimed product that can be re-allocated. In this system, sales administrators make changes manually and any unclaimed inventory is manually tracked as well. Sales administrators also utilize an advertisement planning system that reserves product for the specific purpose of advertising. These ad commitments are manually entered into the spreadsheet to reserve the inventory. If changes are made to the spreadsheet, the information therein must be updated in the computer system in order to implement the changes. Thus, in this and other similar prior systems there is an inefficient cycle of updating numbers in different areas. In addition, because of manual entry, there is an increased chance of data entry errors. Moreover, the spreadsheet-based systems do not provide an efficient and flexible tool that can be used to dynamically allocate product using past and present information.

The system and method described herein provide an automated system for managing the distribution of product. More specifically, the invention provides a sales administration tool that enables sales allocations to be determined and administered in a dynamic manner that accounts for known and available information, while also enabling sales administrators to make final allocation decisions. The invention promotes smooth and effective sales allocations that can be used for a variety of products using different allocation methods that can be defined in the system.

### BRIEF DESCRIPTION OF THE DRAWINGS

These and other features and advantages provided by the invention will be better and more completely understood by referring to the following detailed description of presently preferred embodiments in conjunction with the drawings, of which:

FIG. 1 depicts an illustrative supply chain in which the systems and methods described herein may be implemented;

FIG. 2 is a block diagram of an example product demand system;

FIGS. 3A-3B illustrate database portions of a sales database;

FIG. 4 is an example computer system on which the launch curve tool may be executed;

FIG. 5 is chart of the main steps performed by the sales administrator and the dynamic allocation system in accordance a with preferred embodiment of the instant invention;

FIG. 6 is a flow chart of the main activities that occur in the dynamic allocation system of FIG. 5;

FIG. 7 is a state chart for the dynamic allocation system of FIG. 5; and

FIGS. 8-20 are screen shots illustrating a preferred implementation of the dynamic allocation system of the present invention.

### DETAILED DESCRIPTION OF EXAMPLE EMBODIMENTS

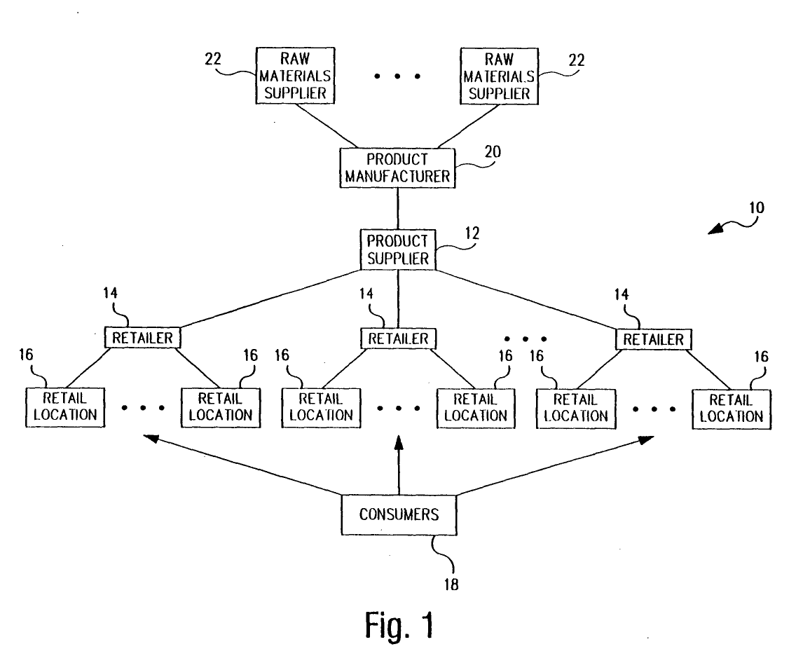

FIG. 1 is a simplified block diagram illustrating one type of supply chain 10 in which the systems and methods described herein may be implemented. In supply chain 10, a product supplier 12 supplies products to a plurality of different retailers 14. Retailers 14 may each have one or more retail locations 16 (e.g., brick-and-mortar stores, web-sites, etc.) in which the product is made available to consumers 18. In supply chain 10, retailers 14 are each responsible for allocating the product among its associated retail outlets. “Product” as used herein is intended to refer to any product made available to consumers. The system and method described herein are particularly useful with video game products such as game machines, games cartridges (in the form of semiconductor or optical memory media, for example), game machine accessories and other products for which there is a higher demand than available industry, thereby requiring effective product distribution. Product supplier 10 may obtain product from a product manufacturer 20. Product manufacturer 20 receives various raw materials for manufacturing the product from raw material suppliers 22.

The invention can be used with other supply chain configurations as well as that of FIG. 1. For example, the product supplier may supply product directly to retail locations. The product is then made available to consumers at retail locations. In this supply chain more than one retail outlet may be associated with a particular retailer. Thus, in this supply chain, rather than the retailer determining allocation of product to its retail outlets, the supplier determines the allocation. As in supply chain 10, product supplier 10 may obtain product from a product manufacturer 38 and product manufacturer 38 receives various raw materials for manufacturing the product from raw materials suppliers 40.

The supply chains shown in FIG. 1 and discussed above are provided by way of illustration, not limitation. It will be apparent from the discussion below that the systems and methods described herein are readily applicable to supply chains other than those expressly discussed herein. Moreover, the systems and methods described herein are not limited to any particular business relationship between the product manufacturer and the product supplier or between the product supplier and the retailers. Thus, for example, the product retailers may purchase product from the product supplier or may take the products on-credit pending sale to a consumer. Consumers may either purchase the product from the retailer or in some instances lease the product from the retailer (or some entity designated by or associated with the retailer).

The product allocation system of the present invention includes an allocation processing system which may, for example, be implemented on a computer system such as an IBM AS400 computer system. The allocation processing system uses a software engine programmed in accordance with the principles described below to calculate an allocation of product. The allocation may, for example, be an allocation to retailers. A demand plan system is coupled to the allocation processing system. The demand plan system is also implemented on a computer system and generates demand data regarding the anticipated future demand for the product whose allocation is to be determined by the allocation processing system. This demand data is supplied to the allocation processing system over a communication link. In addition, the allocation data generated by allocation processing system may be communicated to the demand plan system over a communication link. The communication link may be any conventional communication link that permits communication between two computer systems, and the allocation processing system and the demand plan system are configured with communication circuitry necessary to effect communication over the communication link (e.g., network interface, modem). An ad planner system is coupled to the allocation processing system. The ad planner system is implemented on a computer system and generates ad data regarding advertisements and promotions involving the product whose allocation is to be determined by the allocation processing system. For example, an ad planner system may generate data indicating that the product will be sale-priced by retailer A for a particular time period (e.g., a holiday week-end). The ad planner system may also generate data indicating that a retailer will be running advertisements (e.g., print ads, radio ads, television ads, etc.) advertising the availability of the product. The ad data/demand data is supplied to the allocation processing system over a communication link. In addition, allocation data generated by the allocation processing system may be communicated to an ad planner system over a communication link. The communication link may be any conventional communication link that permits communication between two computer systems, and that allocation processing system and ad planner system are configured with communication circuitry necessary to effect communication over the link (e.g., network interface, modem). Communications between and among the allocation processing system, the demand plan system and the ad planner system may be initiated in response to user commands or may be programmed to occur automatically in response to a particular occurrence (e.g., when particular data is updated or recalculated) or periodically (e.g., every day, every week, etc.).

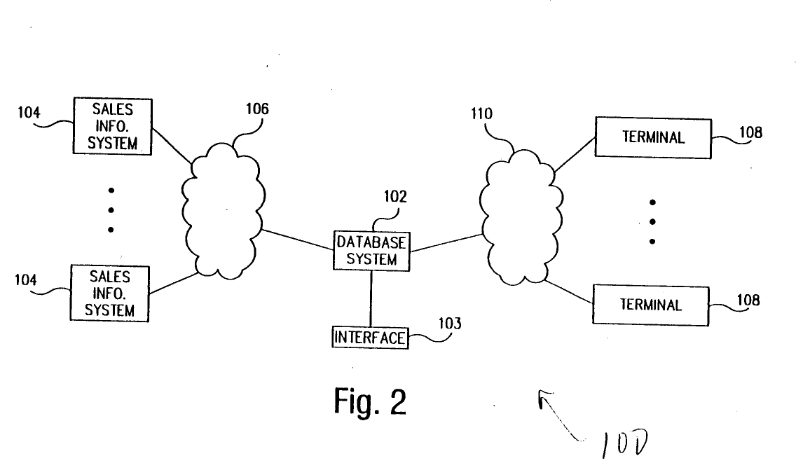

The allocation processing system may be implemented on a computer system generally configured along the lines shown in FIG. 2. Computer system 500 includes a processing unit 502 and a system memory 504. A system bus 506 couples various system components including system memory 504 to processing unit 502. System bus 506 may be any of several types of bus structures including a memory bus or memory controller, a peripheral bus, and a local bus using any of a variety of bus architectures. System memory 504 includes read only memory (ROM) and random access memory (RAM). A basic input/output system (BIOS), containing the basic routines that help to transfer information between elements within computer system 500 is stored in the ROM. Computer system 500 further includes various drives 508 and associated computer-readable media 511. For example, a hard disk drive may read from and write to a (typically fixed) magnetic hard disk. A magnetic disk drive may read from and write to a removable “floppy” or other magnetic disk. An optical disk drive may read from and, in some configurations, writes to a removable optical disk such as a CD ROM or other optical media. Appropriate interfaces 510 may be provided to interface the various drives 508 to system bus 506. The drives and their associated computer-readable media provide nonvolatile storage of computer-readable instructions, data structures, program modules, and other data for computer system 500 including, but not limited to, the dynamic allocation tool described herein.

A user may enter commands and information into computer system 500 through input devices 512 such as a keyboard, pointing device, microphones, or the like. These and other input devices can be connected to processing unit 502 through an interface 514 (e.g., a serial port interface) that is coupled to system bus 506, but may be connected by other interfaces, such as a parallel port, or a universal serial bus (USB). Computer system 500 will typically include output devices 516, such as monitors, printers, speakers and other standard peripheral devices, connected to system bus 506 via interface 518. Computer system 500 may also include communication circuitry 520 (e.g., a modem or other network interface circuitry) for establishing communications over a communication network such as the Internet. Communication circuitry 520 is connected to system bus 506 via an interface 522 (such as a serial port).

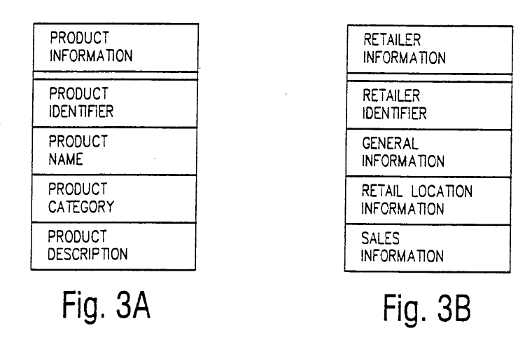

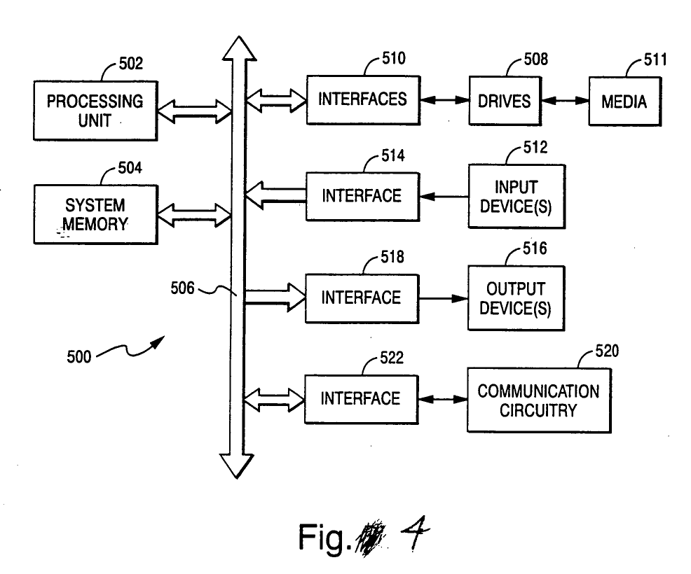

FIG. 2 is a block diagram of an example product demand system 100. While the invention is not directed to the product demand system itself, a brief description of the preferred demand system will now be described. Product demand system 100 includes a database system 102 which may, for example, be an ORACLE® database running on a computer system such as an IBM AS400 computer system. The database system 102 stores a product sales information database. The database may include a relational database comprising a number of related tables that store the product sales information. For example, with reference to FIG. 3A, for each product, the database may store a unique product identifier, a product name, a product category (e.g., racing game, adventure game, etc.) and a product description. With reference to FIG. 3B, for each retailer, the database may store a unique retailer identifier, general retailer information (headquarters address information, phone/fax numbers, contact information, etc.) and retail location information (retail location address information, phone/fax numbers, contact information, etc.). The database also stores sales information for each retailer. This sales information is periodic (e.g., weekly, biweekly, monthly, etc.) and comprises the number of sales of each product for that period. The sales information may be cumulative sales information for all the retail locations of a particular retailer. Alternatively, the sales information may be sales information on a per retail location basis. One advantage of maintaining sales information on a retail location basis is that the address information of each retail location may be used to generate sales information for particular geographic regions. Thus, for example, the database may easily be queried to provide sales information for all the retail locations (regardless of the retailer) in a given country or in a given state in the United States. Countries or states may be grouped together to define regions (e.g., Northeast, Northwest, Europe, etc.) and thus the database may also be easily queried to provide sales information for all the retail locations in a given region. It will of course be appreciated that the elements of the database set forth above are provided by way of example only.

The product sales information in the database is periodically updated. The sales information updates may be entered directly into the data system 102 through an associated user interface 103 (e.g., a keyboard, pointing device, and display) or via remotely located sales information systems 104 such as may be associated with retailers and/or retail locations. These information systems 104 communicate sales data to data system 102 over a wired or wireless communication link 106 such as the Internet. The sales information includes at least the number of sales of a particular product for a particular period of time. In the case of video games, for example, the sales information may include the number of sales of a particular video game during a predetermined period (e.g., a week, a month, etc.). As will be described in greater detail below, the product demand system provides information to the allocation system described herein and enables the allocation system to, among other things, improved product allocation to retail outlets or the like.

The data system 102 is connected to terminals 108. Terminals 108 are computer systems programmed to implement the product demand system and method described herein and to access the sales information database of data system 102. This access may be made using any conventional wired or wireless communication link 110. In an alternative example embodiment, the database system 102, sales information systems 104 and terminals 108 may all be interconnected via the same communication link such as the Internet. In one particular implementation, the system and method are implemented using a spreadsheet application such as Microsoft® Excel® running on a personal computer system and programmed to execute macros and Visual Basic routines. An ODBC driver may be installed on the computer system to retrieve data from the data system 102. It will be recognized that other applications such as database applications (e.g., Microsoft® Access®) may be conveniently used to implement the system and method described herein. In addition, it will be recognized that the terminals 108 may be other types of computer devices such as workstations, laptop computers, personal digital assistants (PDAs) and the invention is not limited in this respect.

While the data system 102 and terminals 108 are implemented using separate computer systems in FIG. 2, it is possible that a single computer system (e.g., workstation, personal computer, laptop computer, personal digital assistant, etc.) may be used to store the sales information database and to implement the product demand system and method described herein.

The preferred implementations and features of the allocation system of the instant invention will now be described. Suppose, for example, that there are ten retailers in a particular geographic region (e.g., the United States) selling a particular product. Typically, these retailers sell different amounts every week. The retailers purchase product from a manufacturer, take the product into their inventory, and then sell the product to consumers. The system and method described herein are designed to allocate product to the retailers in the most effective manner based on a variety of business rules. For example, the system may be designed so that all of the retailers run out of product at approximately the same time. Thus, product is divided among retailers so that, if there is a short supply, all of the retailers run out on at approximately the same time (e.g., on the same day). Thus, there is no advantage to any one retailer over another and there is no product in the wrong place. Allocating product in a manner that causes the retailers to run out of product at approximately the same time is only one exemplary business rule that can followed by the allocation system of the invention. Any other suitable business goals can be achieved using the allocation system of the invention by defining specific allocation methods for products, as will be explained in detail below.

The system operates using information supplied from retailers (e.g., what they own and what they are selling) and using a sales forecasting system to intelligently calculate how long the supplies will last. In this example, the present system and method looks at all ten retailers and divides up the product fairly among those retailers based on a defined allocation method. The system uses information on inventory that is on hand and inventory that is expected to arrive. System and method can be extended to inventory that is not here yet. The system enables a much more granular level of information to be considered as compared to prior systems. For example, past system may indicate that 1,000,000 pieces of a particular product have been shipped and that if 300,000 have been sold, thus leaving 700,000 remaining at a particular point in time. These remaining products could be viewed as being sufficient to handle the market. However, at another level, this information could be viewed on retailer-by-retailer basis. Thus, store A may have a 10-week supply on-hand and store B may have a 4-week supply on-hand. If the marketer has 50,000 units for distribution, the present allocation system and method can be used to determine how best to allocate this remaining product to those retailers.

The system is supplied with weekly sell-though data from the retailers. Thus, if product is shipped weekly and the supply becomes short, the system enables the sales administrator to look at particular stores that have longer weeks of supply than those that are running out and then adjust the allocation to increase product to the stores that are running out. The system also has an understanding of the supply chain (e.g., how much inventory is on hand, how much is on order, when will it arrive, how much needs to be ordered, when it will arrive if ordered, etc.). Based on all of the information available to the system, logical decisions regarding allocations can be made so that, for example, everyone has the same relative amount of supply when the supply is adjusted for various anticipated or actual rates of sale, etc. The system will know how long it will take to sell the amount of inventory that a retailer has based on retailer-specific data and on other data such as seasonal (e.g., Christmas) data, as well as on how much additional inventory is being or going to be sent. The system maintains the levels of inventory available by retailer and can change it dynamically based on sales results that are happening for all retailers. Thus, the system does not just show how this retailer is doing, but it enables changes to be dynamically made based on a variety of factors, all of which can be defined through the system by the administrators and applied on a product-by product or product group basis.

The allocation system is preferably configured to enable a supplier to establish a uniform supply to all retailers. For example, the product supplier could determine that it wishes to have n weeks of product supply at all retail locations. Then, when orders come in for individual stores, the system can determine whether to ship or not ship particular orders based on the information in the system. This can be important in view of the varying lead times on product. The system and method of the invention can be extended to take into account products that can be manufactured in a short time period (e.g., 2 or 3 days). Thus, the system can take into account what is currently on-hand and what can be built in the short-term. Thus, certain orders may be held today because the product can be built and shipped in 2 or 3 days. Thus, the system and method can control what goes down to the shipping room floor to be shipped. As a result, the system can be advantageously used to take into account retail sales changes, supply changes, advertising changes, as well as other suitable variables when allocating products. It is noted that the manufacturing, replenishment and planning (MRP) system typically uses gross inventory to determine quantities. New products sell at very different rates. Thus, the system can be used to control where inventory goes based on these rates (e.g., weekly and daily rates). Lead times from another company, such as a parent corporation, may also be taken into account in the allocation processing.

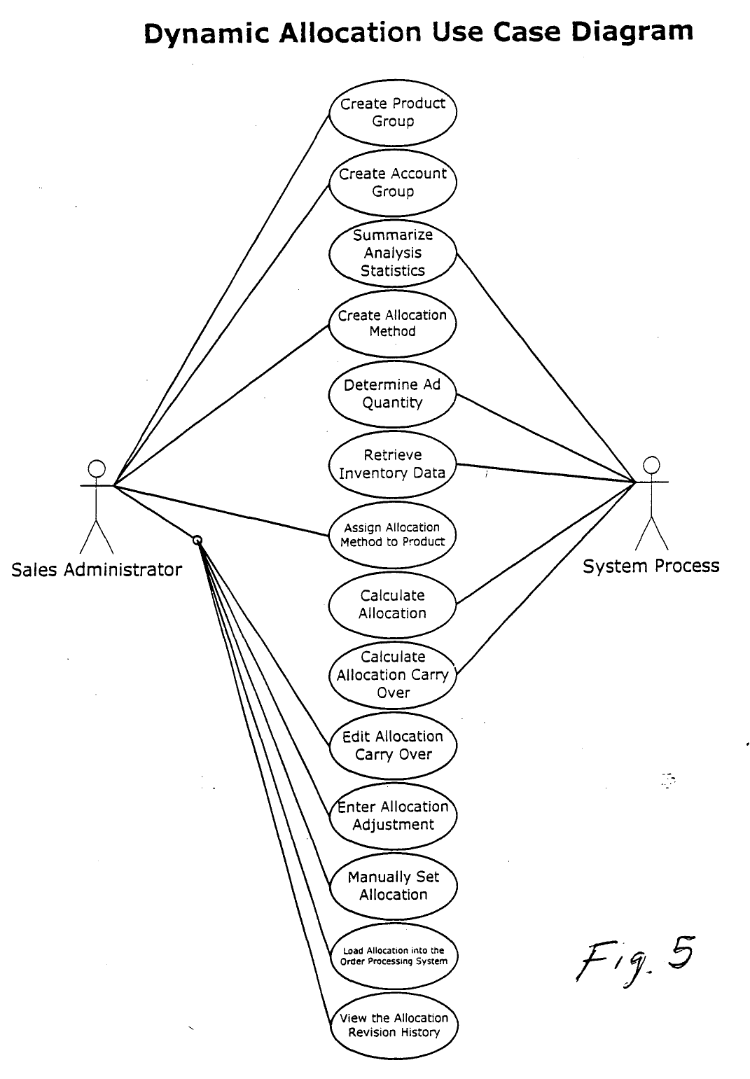

FIG. 5 shows a chart of the main processes used in accordance with the preferred embodiment of the dynamic allocation system of the instant invention. As shown in FIG. 5, the system itself has various functions and the sales administrator has various functions. For example, the sales administrator creates a product group, creates account groups, creates allocation methods, assigns allocation methods to products, edits allocation carry over, enters allocation adjustment, manually sets allocation, loads allocation into order processing system, and views the allocation revision history. On the other hand, the dynamic allocation system process summarizes analysis statistics, determines ad quantity, retrieves inventory data, calculates allocation and calculates allocation carry over. Together the sales administrator and the system are able to allocate product for product launches and replenishment in an efficient and effective manner by taking into account the available historical and present information.

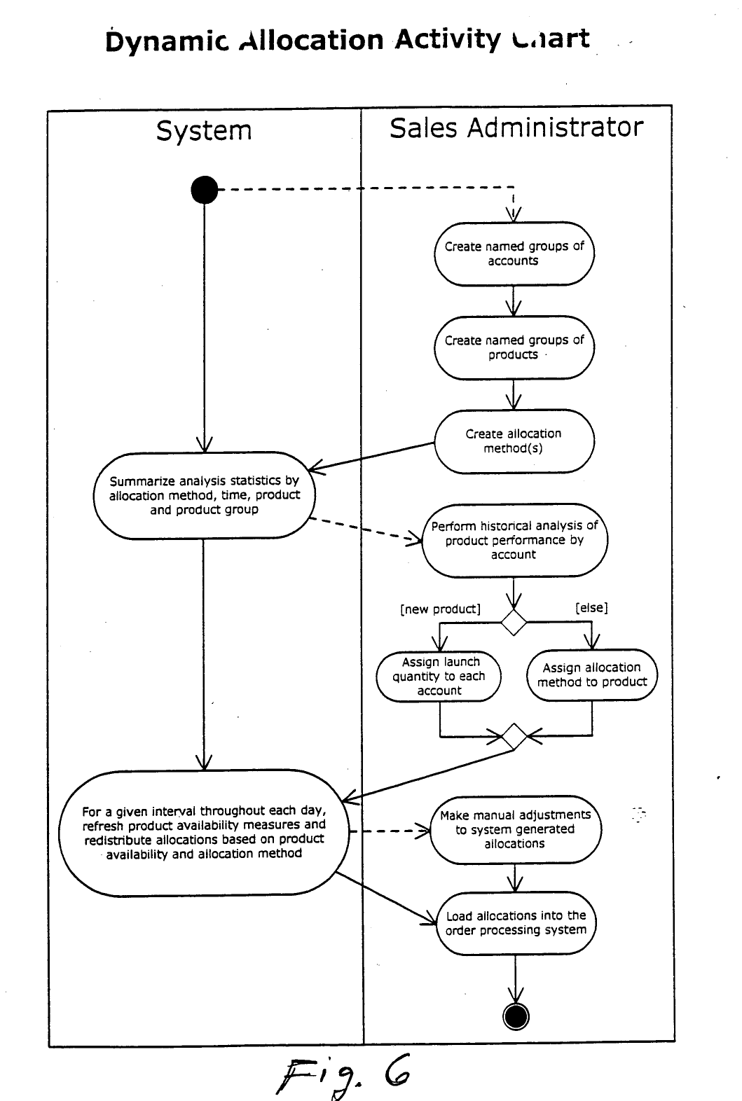

FIG. 6 shows a flow diagram of the dynamic allocation system of the preferred embodiment. The sales administrator creates named groups of accounts. Groups of accounts may be defined in a manner, such as top ten accounts for the administrator, top nine accounts for the company, etc. The administrator also creates named groups of products. For example, similar products (e.g., similar software products) may be grouped together and handled as a group in the system. The administrator also defines allocation methods for use on the system. These allocation methods may be fixed, variable or dynamic. They preferably relate to historical data as explained in detail below. In the meantime, the dynamic allocation system summarizes analysis statistics by allocation method, time, product and product group. Using these statistics, the sales administrator performs a historical analysis of a product performance by account. If its a new product, the sales administer assigns a launch quantity to each account. If its a replenishment of an existing product, the sales associate assigns an allocation method to the product. Then, for a given interval throughout each day, the allocation system refreshes product availability measures and redistributes allocations based on product availability and allocation method. The sales administrator can make manual adjustments to system generated allocations. The sales administrator then loads the allocations into the order processing system.

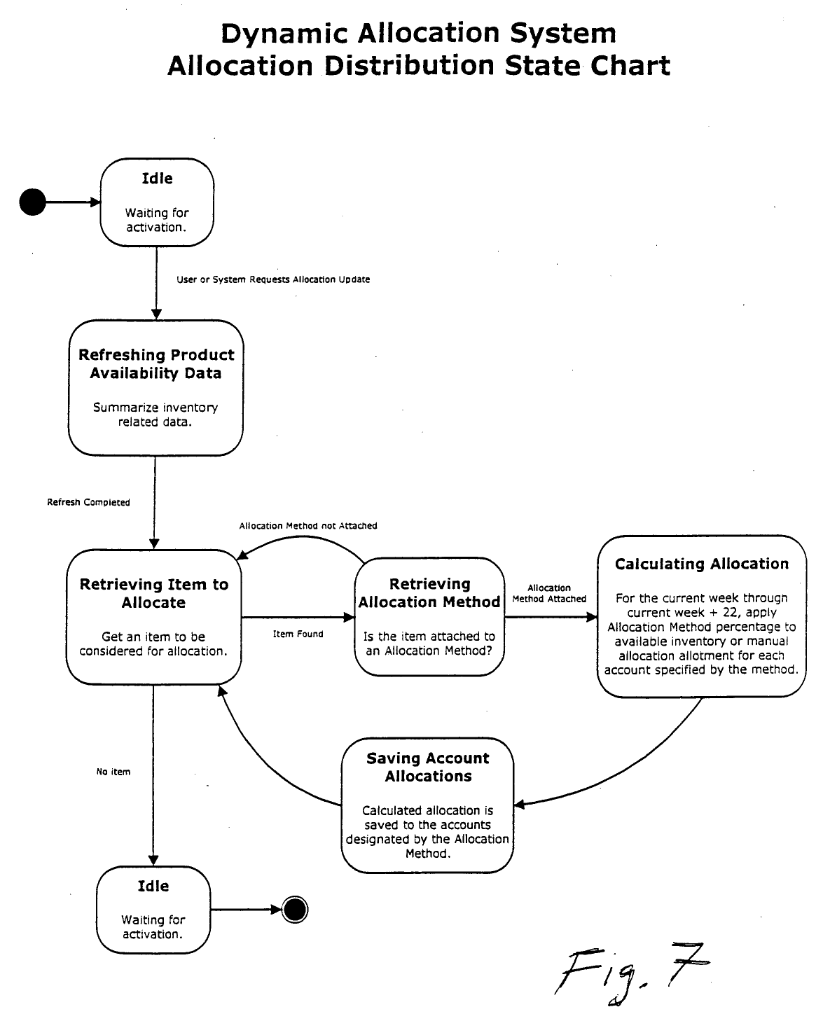

FIG. 7 provides a preferred state chart for the dynamic allocation system of the present invention. As shown in FIG. 7, the system is idle until it is activated as a result of the user or the system itself requesting an allocation update. Upon activation, the system refreshes the product availability data by summarizing inventory related data. When the refresh is complete, the system retrieves a product (item) to allocate. If no item is found, the system returns to its idle state. If an item is found, the system retrieves an allocation method if the item as been assigned an allocation method. If an allocation method has not been found the system returns to the previous state. If an allocation method is attached to the item, the allocations are calculated in accordance therewith. For example, for the current week through the current week plus 22 weeks, the system may apply an allocation method percentage to available inventory or a manual allocation allotment for each account specified by the method. The system then saves the account allocations by storing the calculated allocations to the accounts designated by the allocation method. The system then repeats the above steps as appropriate or desired.

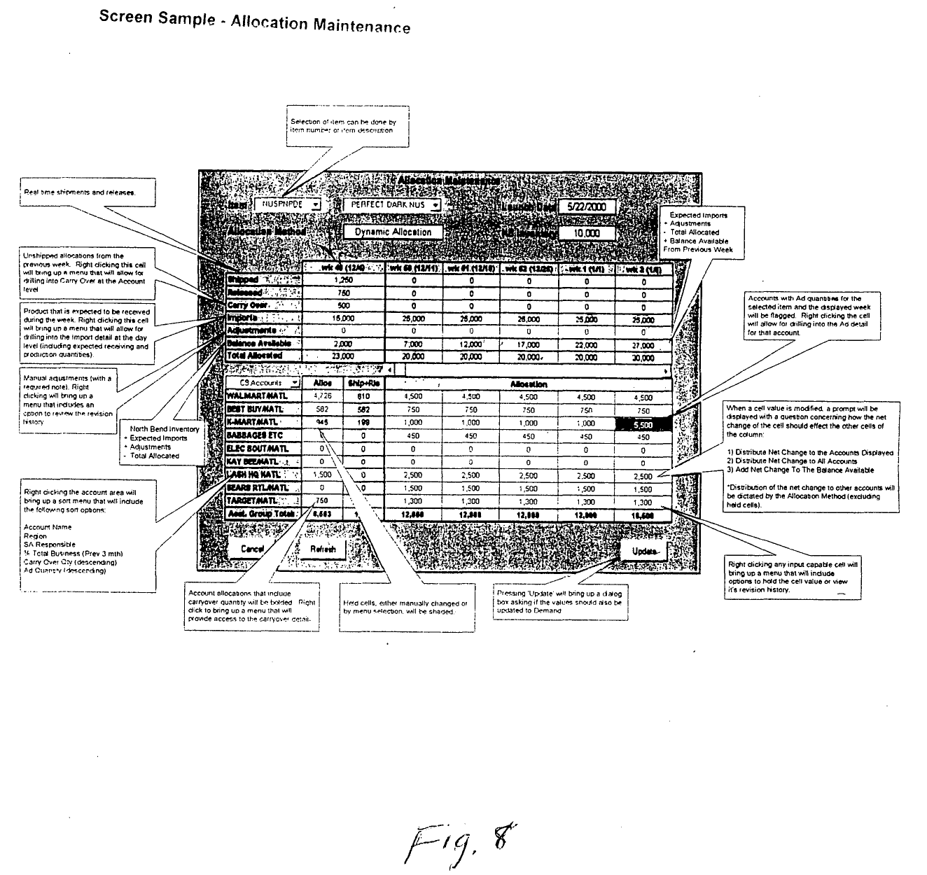

A preferred embodiment of the user interface and system functionality will now be described with reference to the exemplary screen shots of FIGS. 8-20. As seen in FIGS. 8-20, the invention provides a system that will enable Sales Administrators to easily plan and manage product allocations. Data within the dynamic allocation system is available to other software systems (Order Processing, DAR, Ad Planner, Business Objects, etc). A security scheme is preferably provided that requires a user name and password to access the system. For auditing purposes, all work done while in the system is logged and noted and access to a revision log is provided. The dynamic allocation system data is preferably retained for one year. E-mail notifications are automatically sent to alert users to changes of vital system values (e.g. allocation quantities). The system flags price changes in the system in order to anticipate resulting sales lift, as well as tracks allocation of pre-sell product. Indications are provided for active/inactive/new products. Screens display when the last update of an object occurred (i.e. user, date, time). The design of each module takes into consideration that analysis at the daily level may be required soon after the implementation of the system. There are also a few levels of “Undo” for each screen.

In the preferred embodiment, the dynamic allocation system includes implementation of the following interactive modules, each of which are described separately below:

Allocation Maintenance—The heart of the Dynamic Allocation System, this module provides a tool to analyze allocations and load them into the Demand System. This interface also provides a means to “balance the checkbook” of current allocations and available product.

Import Detail—A “drill down” screen from the Import cell in Allocation Maintenance, Import Detail breaks out expected production builds and finished goods receipts at the day level.

Account Carry Over Detail—A “drill down” screen from a Carry Over cell in Allocation Maintenance, this module will provide read/write access to each account's carryover quantity.

Replenishment Item Set Up—The primary function of this module is the application of an Allocation Method to an item. The screen will provide side-by-side comparison of items, which includes their respective performance based on a user selected measure and time interval.

Launch Item Set Up—This module provides an analysis tool to set the account allocation quantities for a product launch. Analysis criteria include Forecast data and Allocation Method percentages by a user defined measure and time interval.

Demand Update—Providing a direct link to the Demand System, Sales Administrators can update or display various demand flags and/or demand buckets.

Demand Weekly Update—This module is a “Drill Down” screen from Demand Update. Right clicking a Demand Update month will invoke this module, which lists the Demand buckets by week.

Manual Allocation % Maintenance—Provides the means to define static allocation percentages (Methods) in which to base product allocations. Side-by-side comparisons of existing Allocation Methods provides the analysis for building these new, static, methods.

Item Classification—This module allows users to view the products that have been assigned to an Allocation Method. Products can also be given new Allocation Method assignments in this module.

Time Driven Allocation Maintenance—Time driven (or rolling time period) methods are defined using this module, and include such parameters as Interval, Lag, Range and Starting Point.

Account Group Maintenance—Product Group Maintenance—Method Group Maintenance. These three modules provide the same general function of creating groups of related objects that can be easily pulled into analysis modules.

Each of these main modules will now be discussed in further detail with reference to FIGS. 8-20.

Allocation Maintenance

The allocation maintenance screen of FIG. 8 is the heart of the Dynamic Allocation System, this module provides a tool to analyze allocations and load them into the Demand System. This interface also provides a function to “balance the checkbook” of current allocations and available product. The screen preferably also shows review history shipments, sell thru and store inventory (by week and/or day). It is possible that the Demand System bucket that this system feeds (Autoflow Qty) can be changed through the current Demand System programs. If this occurs, there is the potential that the Demand System and the Dynamic Allocation System (DAS) will be “out of sync”. If this occurs, DAS users will be notified with a unique color coding of the cells that are “out of sync”.

The following terms in the Allocation Maintenance screen of FIG. 8 are defined as follows:

Shipped: Gross shipments for the week.

Released: Orders that have been released to the warehouse and are awaiting shipment.

Carry Over Quantity: Allocated quantity from the previous week that was not shipped due to insufficient order quantity by an account (the account did not have shipments equal to the order quantity that was allocated to them).

Adjustments: Manual adjustments made by Sales Admin that compensate for quantities not available to the Dynamic Allocation System, or to adjust faulty data (i.e. Import data that has not been entered into the system or an unexpected promotional quantity).

Inventory: The inventory at the work center, or possibly a combination of work centers that indicate inventory of third party warehouses. If the latter is the case, then a detail screen will be available to drill to.

Imports: Expected receipts of finished good product (including production builds) into available inventory. A detail screen can be drilled to (see the Import Detail screen).

Balance Available: Available product that has not been allocated. (Inventory+Imports+Adjustments=Total Allocated)

Allocation Method: The method used to produce the initial Allocation quantities for a given week. Allocation methods are applied nightly to all future weeks (excluding held cells).

Ship+Rls: Real time Shipments+Releases for a specific account.

As shown in FIG. 8, selection of an item can be done by item number or item description. The balance available is calculated as follows: Expected Imports+Adjustments−Total Allocated+Balance Available From Previous Week. Accounts with Ad quantities for the selected item and the displayed week are flagged. Right clicking the cell allows for drilling into the Ad detail for that account. When a cell value is modified, a prompt is be displayed with the following question concerning how the net change of the cell should effect the other cells of the column: 1) Distribute Net Change to the Accounts Displayed, 2) Distribute Net Change to All Accounts, 3) Add Net Change To The Balance Available. The distribution of the net change to other accounts is dictated by Allocation Method (excluding held cells). Right clicking any input capable cell brings up a menu that includes options to hold the cell value or view it's revision history. Pressing “Update” brings up a dialog box asking if the values should also be updated to the demand system (Demand). Held cells, either naturally changed or by menu selection, are shaded. Account allocations that include carryover quantity are bolded. Right clicking brings up a menu that will provide access to the carryover detail. Right clicking the account area brings up a sort menu that includes the following sort options: Account Name, Region, SA Responsible, % Total Business (Prev 3 mth), Carry Over Qty (descending), Ad Quantity (descending). Manual adjustments (preferably with a required note) are allowed. Right clicking will bring up a menu that includes an option to review the revision history. The screen shows product that is expected to be received during the week. Right clicking this cell brings up a menu that allows for drilling into the import detail at the day level (including expected receiving and production quantities). The screen also shows unshipped allocations from the previous week. Right clicking this cell bring up a menu that allows for drilling into Carry Over at the Account level. The screen also shows real time shipments and releases.

Import Detail

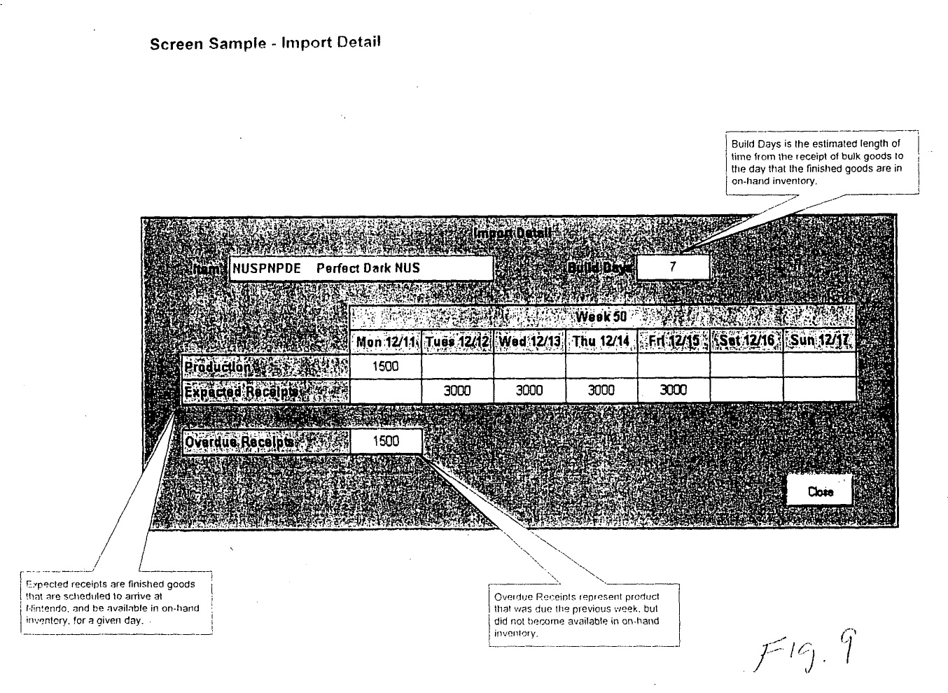

The import detail screen is shown in FIG. 9. This screen is a “drill down” screen from an Imports cell in Allocation Maintenance. Import Detail breaks out expected production builds and finished goods receipts at the day level. In FIG. 9, Build Days is the estimated length of time from the receipt of bulk goods to the day that the finished goods are in on-hand inventory. Production indicates what day bulk goods are due to be completed and become available for allocation. Expected Receipts shows Finished goods that are scheduled to arrive and become available for allocation. Overdue Receipts represent product that was due the previous week, but did not become available and is not represented in the Production or Expected Receipts of the current week.

Account Carry Over Detail

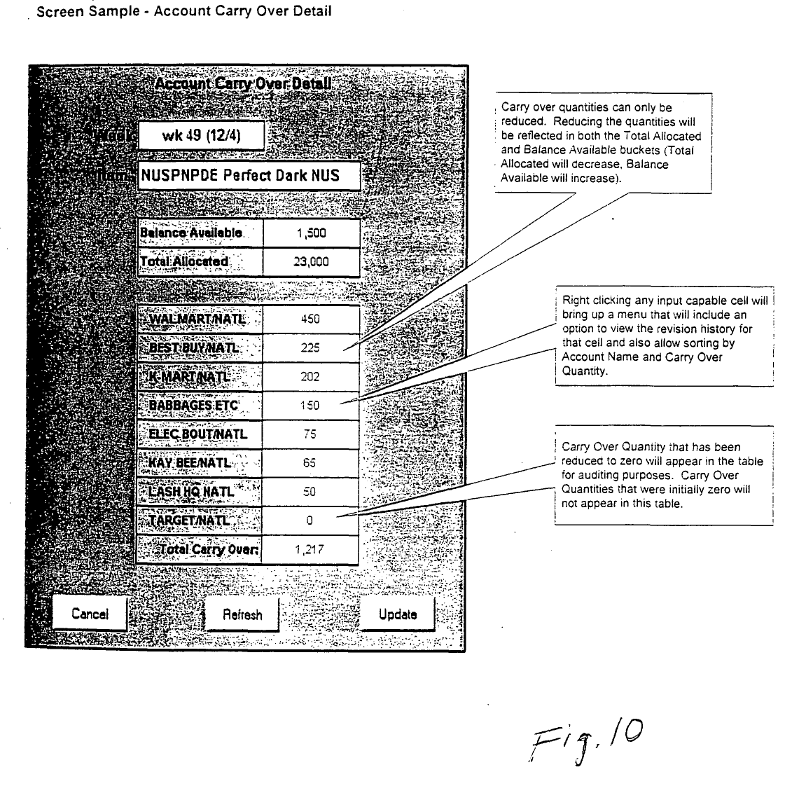

FIG. 10 shows the Account carry Over Detail screen. This screen is a “drill down” screen from a Carry Over cell in Allocation Maintenance, this module provides update access to each account's carryover quantity. As shown in FIG. 10, carry over quantities can only be reduced. Reducing the quantities is reflected in both the Total Allocated and Balance Available buckets (Total Allocated will decrease, Balance Available will increase). Right clicking any input capable cell brings up a menu that includes an option to view the revision history for that cell and also allows sorting by Account Name and Carry Over Quantity. Carry Over Quantity that has been reduced to zero appears in the table for auditing purposes. Carry Over Quantities that were initially zero do not appear in this table.

Replenishment Item Set Up

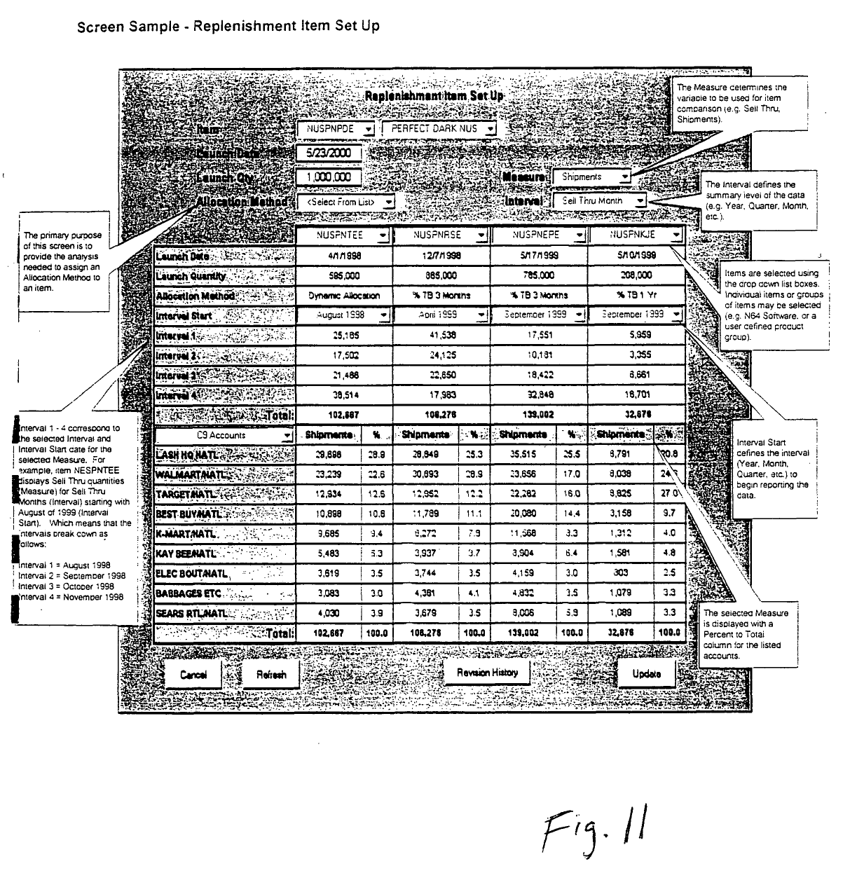

The Replenishment Item Set Up screen is shown in FIG. 11. The primary function of this module is to provide analysis to aid in the selection of an Allocation Method for an item. The screen provides side-by-side comparison of items, which includes their respective performance based on a user selected measure and time interval. In FIG. 11, Allocation Method is the method used to produce the initial Allocation quantities for each account, for a given week. The primary purpose of this screen is to select an allocation method for an item. Allocation methods are also displayed for each item being displayed for analysis. The Launch Quantity is the quantity that was shipped for the launch of the selected item. The Measure is the user selected measure used for comparison purposes between items. The measure is typically Shipments or Sell Thru. The Interval is the time period for which the measure will be reported against (i.e. Sell Thru Month, Calendar Month, Fiscal Year, etc.). The Interval Start is the specific time, reported in units specified by the Interval, that reporting of the measure should begin. Interval 1-4 is related directly to the Interval, these units of time begin at the Interval Start and increment by one Interval for each Interval 1-4.

As shown in FIG. 11, the Measure determines the variable to be used for item comparison (e.g. Sell Thru, Shipments). The Interval defines the summary level of the data (e.g. Year, Quarter, Month, etc). Items are selected using the drop down list boxes. Individual items or groups of times may be selected (e.g. N64 Software, or a user defined product group). Interval Start defines the interval (Year, Month, Quarter, etc.) to begin reporting the data. The selected Measure is displayed with a Percent to Total column for the listed accounts. Interval 1-4 correspond to the selected Interval and Interval Start date for the selected Measure. For example, item NESPNTEE displays Sell Thru Months (Interval) starting with August of 1999 (Interval Start). Which means that the Intervals break down as follows: Interval 1=August 1998; Interval 2=September 1998; Interval 3=October 1998; Interval 4=November 1998. The primary purpose of this screen is to provide the analysis needed to assign an Allocation Method to an item.

Launch Item Set Up

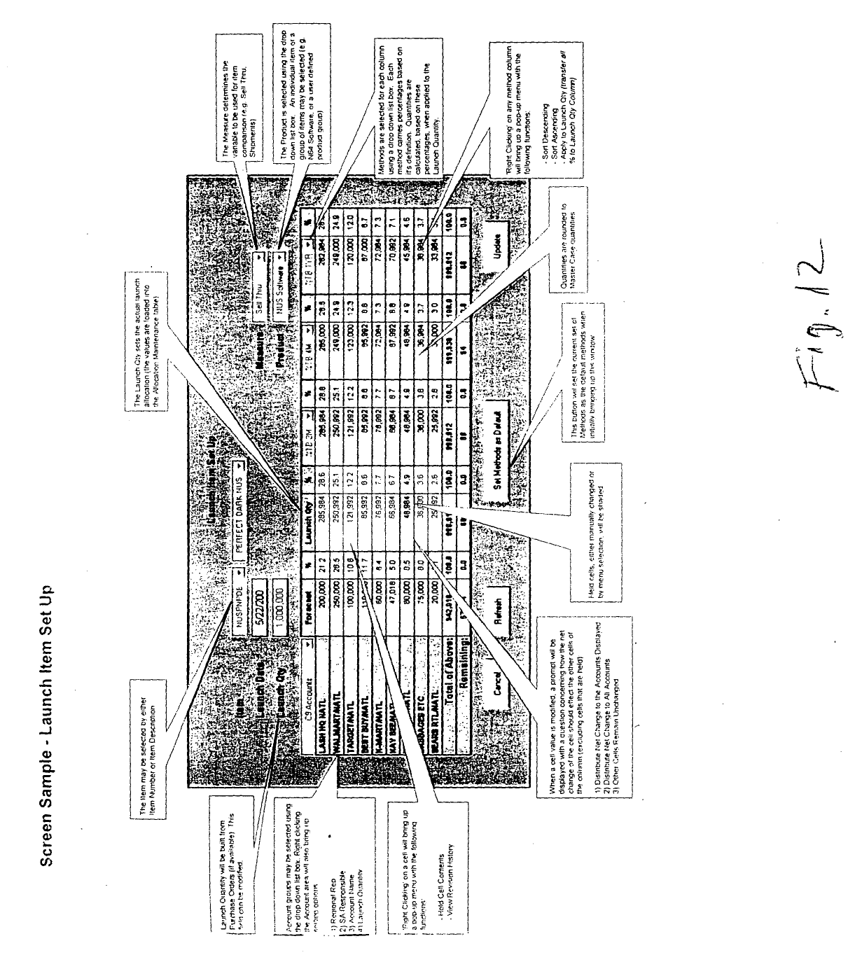

The Launch Item Set Up screen is shown in FIG. 12. As shown in FIG. 12, this module provides an analysis tool to set the account allocation quantities for a product launch. Analysis criteria include Forecast data and Allocation Method percentages by a user defined measure and time interval. In FIG. 12, Measure is the user selected measure used for comparison purposes between items. The measure will typically be Shipments or Sell Thru. Product defines the product set that the analysis data represents. Possible values will be, for example, All Products, NUS Software, or a specific user defined product group. Launch Qty is a value that defaults to the sum of purchase orders for the item, but can be modified to be any quantity. This total is used against the Launch Qty Percentages to determine a Launch Qty for each account that is displayed. The Forecast is the amount of product that the customer requested for the product launch. The Set Methods as Default button allows each user to customize the default methods that are used for analysis.

As shown in FIG. 12, the item may be selected by either item Number or item Description. The Launch Qty sets the actual launch allocation (the values are loaded into the Allocation Maintenance table). The Measure determines the variable to be used for item comparison (e.g. Sell Thru, Shipments). The Product is selected using the drop down list box. An individual item or a group of items may be selected (e.g. N64 Software, or a user defined product group). Methods are selected for each column using a drop down list box. Each method carries percentages based on it's definition. Quantities are calculated, based on these percentages, when applied to the Launch Quantity. “Right Clicking” on any method column brings up a pop-up menu with the following functions: -Sort Descending, -Sort Ascending, -Apply to Launch Qty (transfer all % to Launch Qty Column). Quantities are rounded to Master Case quantities. A button is provided for setting the current set of Methods as the default methods when initially bringing up this window. Held cells, either manually changed or by menu selection, are shaded. When a cell value is modified, the following prompt is displayed with a question concerning how the net change of the cell should effect the other cells of the column (excluding cells that are held): 1) Distribute Net Change to the Accounts Change Displayed, 2) Distribute Net Change to All Accounts, 3) Other Cells Remain Unchanged.

“Right Clicking” on a cell brings up a pop-up menu with the following functions: -Hold Cell Contents, -View Revision History. Account groups may be selected using the drop down list box. Right clicking the Account area brings up sorting options: 1) Regional Rep, 2) SA Responsible, 3) Account Name, 4) Launch Quantity. Launch Quantity is built from Purchase Orders (if available). This field can be modified.

Demand Plan Update

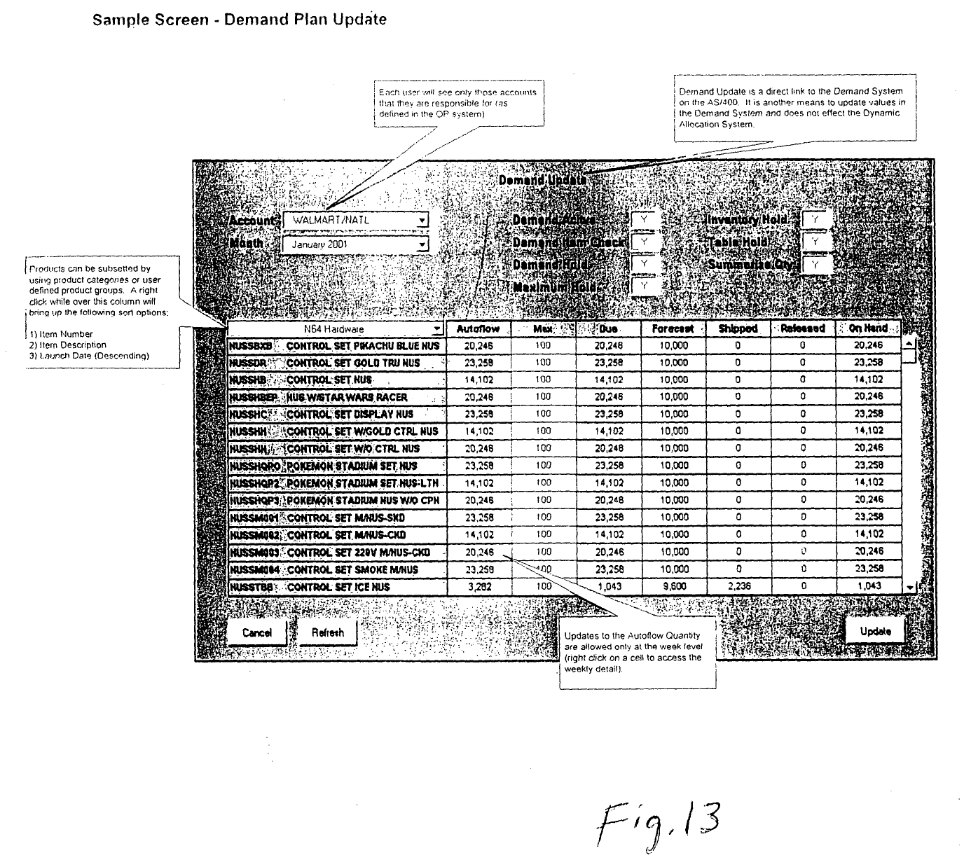

FIG. 13 shows the Demand Plan Update screen. As shown in FIG. 13, this screen provides a direct link to the Demand System. Sales Administrators update or display various demand flags and/or demand buckets. Changes to the Demand System via Demand Update will not effect the values in the Dynamic Allocation System database. The Monthly Autoflow Quantity is the total allocation for the month. The Max Qty is the max quantity of a single order for that item. Due is the quantity available to allocate. Forecast is the Customer Requested Qty. Shipments are the shipments to the customer. Released Quantity is the quantity that has been released, but hasn't shipped. On Hand is the inventory. The “Y/N” flags provide various desired functions as follows: (the interface will allow updates to those flags): Demand Active, Demand Item Check, Demand Hold, Maximum Hold, Inventory Hold, Table Hold, Summarize Qty

As shown in FIG. 13, each user only sees those accounts that they are responsible for (as defined in the OP system). Demand Update is a direct link to the Demand System on AS/400 KHz signal. It is another means to update values in the Demand System and does not effect the Dynamic Allocation System. Updates to the Autoflow Quantity are allowed only at the week level (right click on a cell to access the weekly detail). Products can be subsetted by using product categories or user defined product groups. A right click while over this column will bring up the following sort options: 1) Item Number, 2) Item Description, 3) Launch Date (Descending).

Demand Weekly Detail

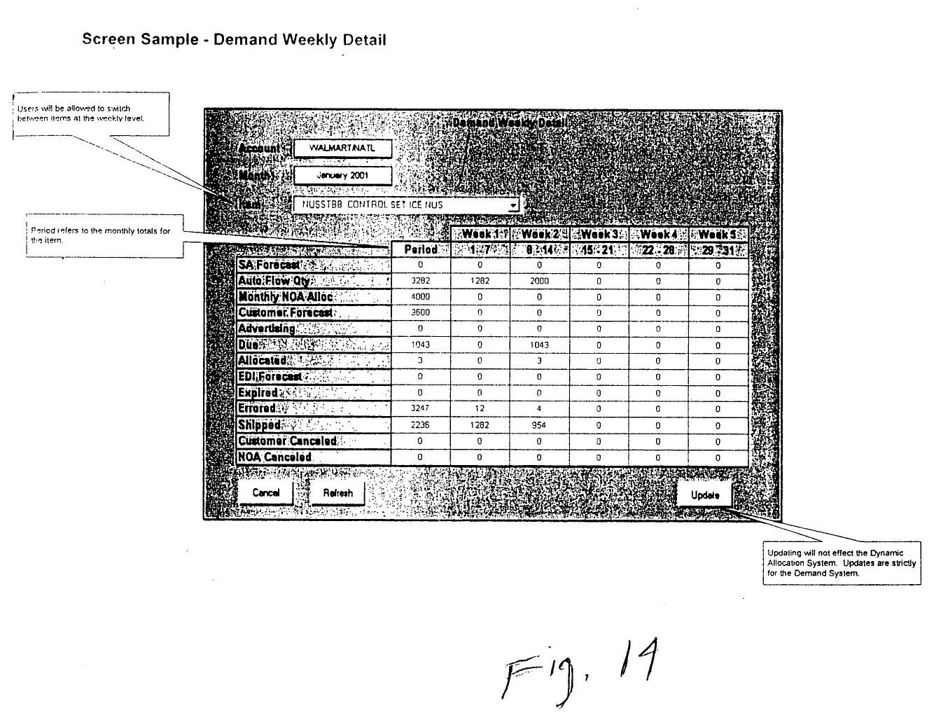

FIG. 14 shows the Demand Weekly Detail screen. As shown in FIG. 14, this module is a “Drill Down” screen from Demand Update. Right clicking a Demand Update month will invoke this module, which lists the Demand buckets by week and allows updates to various Demand System quantities. Updating will not effect the Dynamic Allocation System. Updates are strictly for the Demand System. Period refers to the monthly totals for the item. Users are allowed to switch between item at the weekly level.

Manual Allocation % Maintenance

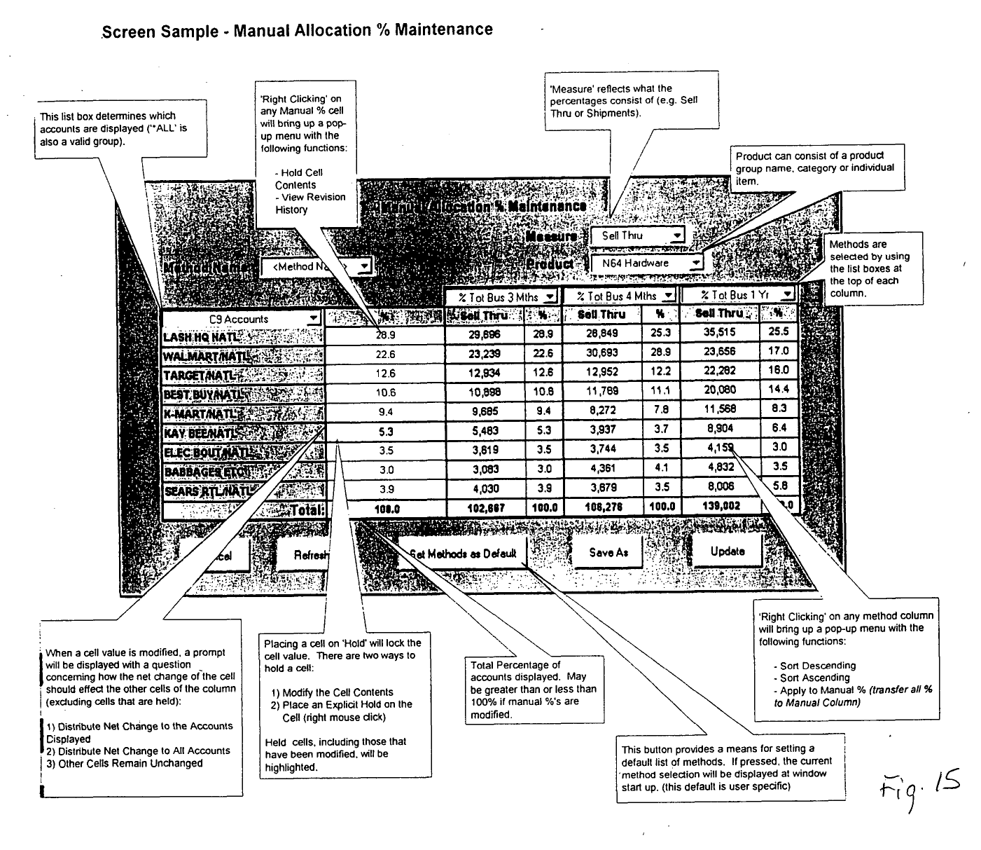

FIG. 15 shows the Manual Allocation % Maintenance screen. This screen provides the means to define static allocation percentages (Methods) in which to base production allocations. Side-by-Side comparisons of existing Allocation Methods provides the analysis for building these new, static, methods. An FIG. 15, Measure is the user selected measure used for comparison purposes between methods. The measure will typically be Shipments or Sell Thru. Product defines the product set that the analysis data represents. Possible values will be, for example, All Products, NUS Software, or a specific user defined product group. “%” is the percentage of available product to allocate to a specific account when using this method.

As shown in FIG. 15, the Manual Allocation % Maintenance screen provides a list box that determines which accounts are displayed (“ALL” is also a valid group). “Right Clicking” on any Manual % cell brings up a pop-up menu with the following functions: -Hold Cell Contents, -View Revision History. “Measure” reflects what the percentages consist of (e.g. Sell Thru or Shipments). Product can consist of a product group name, category or individual item. Methods are selected by using the list boxes at the top of each column. “Right Clicking” on any method column will bring up a pop-up menu with the following functions: -Sort Descending, -Sort Ascending, -Apply to Manual % (transfer all % to Manual Column). A button is provided for setting a default list of methods. If pressed, the current method selection will be displayed at window start up. (this default is user specific). Total percentage of accounts displayed may be greater than or less than 100% if manual %'s are modified. Placing a cell on “Hold” will lock the cell value. There are two ways to hold a cell: 1) Modify the Cell Contents, 2) Place an Explicit Hold on the Cell (right mouse click). Held cells, including those that have been modified, will be highlighted. When a cell value is modified, a prompt will be displayed with a question concerning how the net change of the cell should effect the other cells of the column (excluding cells that are held): 1) Distribute Net Change to the Accounts Displayed, 2) Distribute Net Change to All Accounts, 3) Other cells Remain Unchanged.

Item Classification

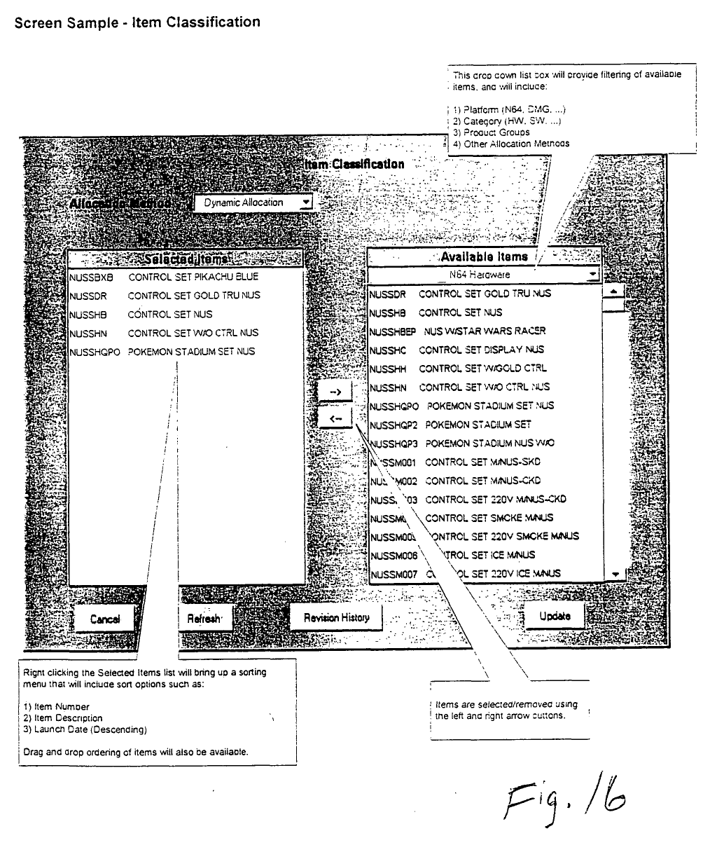

FIG. 16 shows the Item Classification screen. This module allows users to view the products that have been assigned to an Allocation Method. Products can also be given new Allocation Method assignments in this module. As shown in FIG. 16, a drop down list provides filtering of available items, and includes, for example: 1) Platform (N64, DMG, . . . ), 2) Category (HW, SW, . . . ), 3) Product Groups, 4) Other Allocation Methods. Items are selected/removed using the left and right arrow buttons. Right clicking the Selected Items list brings up a sorting menu that includes sort options such as: 1) Item Number, 2) Item Description, 3) Launch Date (Descending). Drag and drop ordering of items is also available.

Time Driven Allocation Method Maintenance

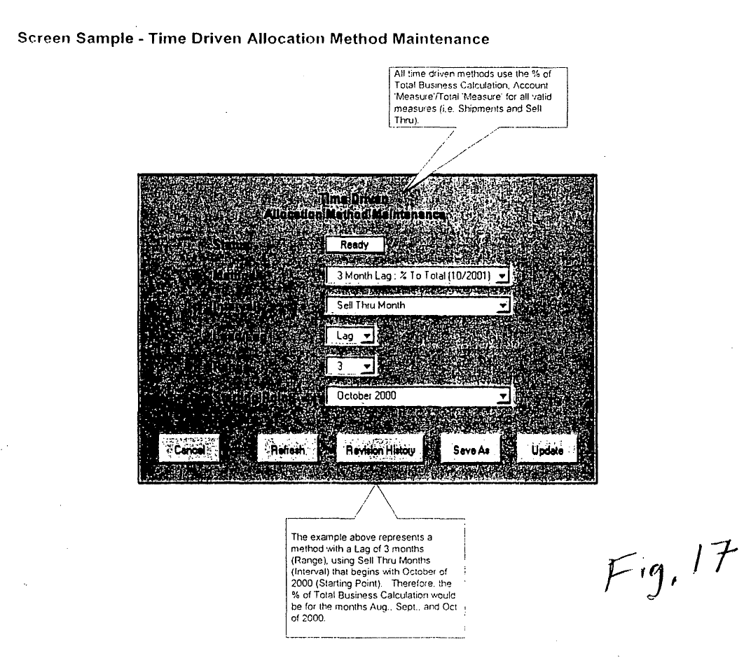

FIG. 17 shows the Time Driven Allocation Method Maintenance screen. Using this screen, time driven (or rolling time period) methods are defined in this module, and include such parameters and Interval, Lag, Range and Starting Point. Status indicates if the summary data needed to support the method has been calculated and stored in the database. Interval determines the time variable used to drive the method (i.e. Sell Thru Month, Calendar Month, Fiscal Year, etc.). Lead/Lag indicates if the method looks forward (Lead) or Backward (Lag) from the starting point. Range identifies the number of intervals to apply to this method. The Starting Point identifies the beginning of the time interval. Possible entries include specific months as well as rolling start points such as the current date, month or year. All time driven methods use the % of Total Business Calculation, Account “Measure”/Total “Measure” for all valid measures (i.e. Shipments and Sell Thru). The example shown in FIG. 17 represents a method with a Lag of 3 months (Range), using Sell Thru Months (Interval) that begins with October of 2000 (Starting Point). Therefore, the % of Total Business Calculation would be for the months Aug., Sept., and Oct. of 2000.

Account Group Maintenance

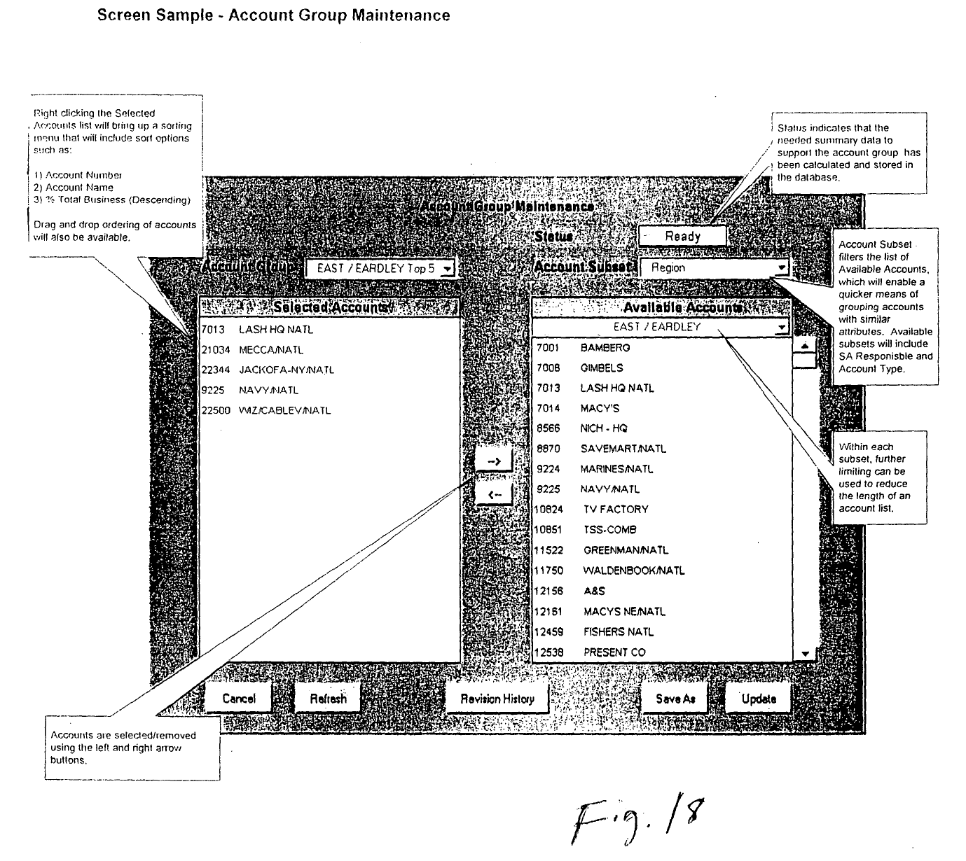

FIG. 18 shows the Account Group Maintenance screen. Account Group Maintenance provides a tool to create subsets of related accounts. DAS analysis data is summarized based on these user defined groups. Status indicates that the needed summary data to support the account group has been calculated and stored in the database. Account Subset filters the list of Available Accounts, which will enable a quicker means of group accounts with similar attributes. Available subsets will include SA Responsible and Account Type. Within each subset, further limiting can be used to reduce the length of an account list. Accounts are selected/removed using the left and right arrow buttons. Right clicking the Selected Accounts list will bring up a sorting menu that will include sort options such as: 1) Account Number, 2) Account Name, 3) % of Total Business (Descending). Drag and drop ordering of accounts is also provided.

Product Group Maintenance

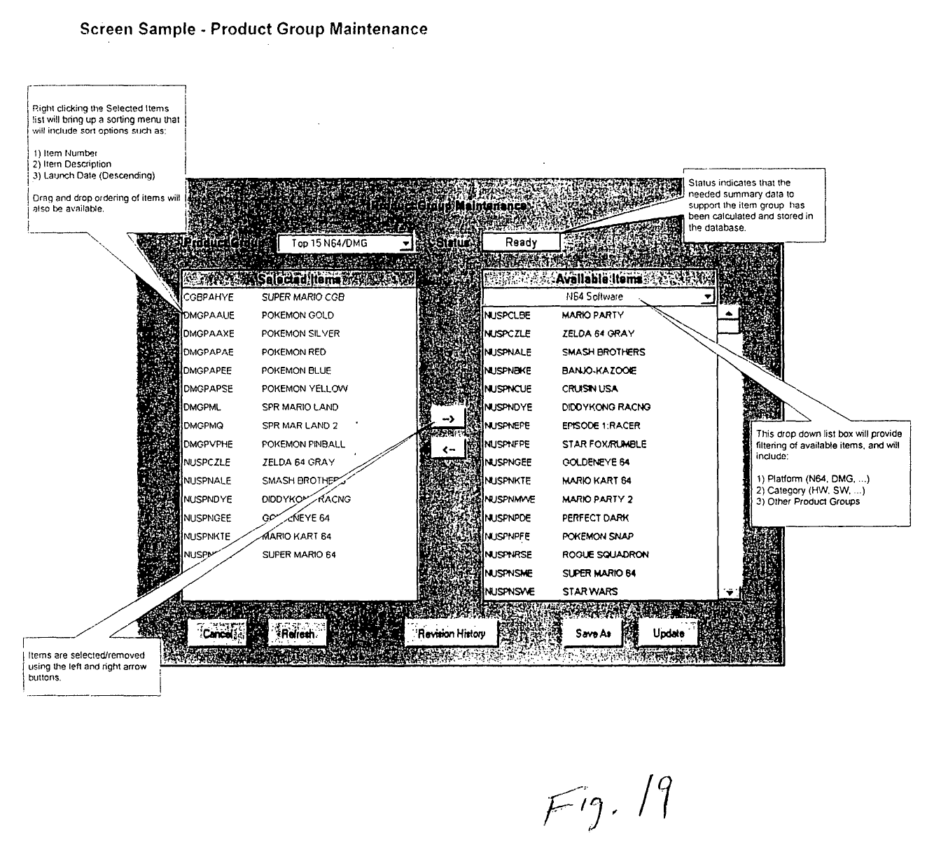

FIG. 19 shows the Product Group Maintenance screen. Product Group Maintenance provides a tool to create subsets of related methods. DAS analysis data is summarized based on these user defined groups. Status indicates that the needed summary data to support the item group has been calculated and stored in the database. A drop down list box provides filtering of available items, and includes, for example: 1) Platform (N64, DMG, . . . ), 2) Category (HW, SW, . . . ), 3) Other Product Groups. Items are selected/removed using the left and right arrow buttons. Right clicking the Selected Items list will bring up a sorting menu that will include sort options such as: 1) Item Number, 2) Item Description, 3) Launch Date (Descending). Drag and drop ordering of items is also provided.

Method Group Maintenance

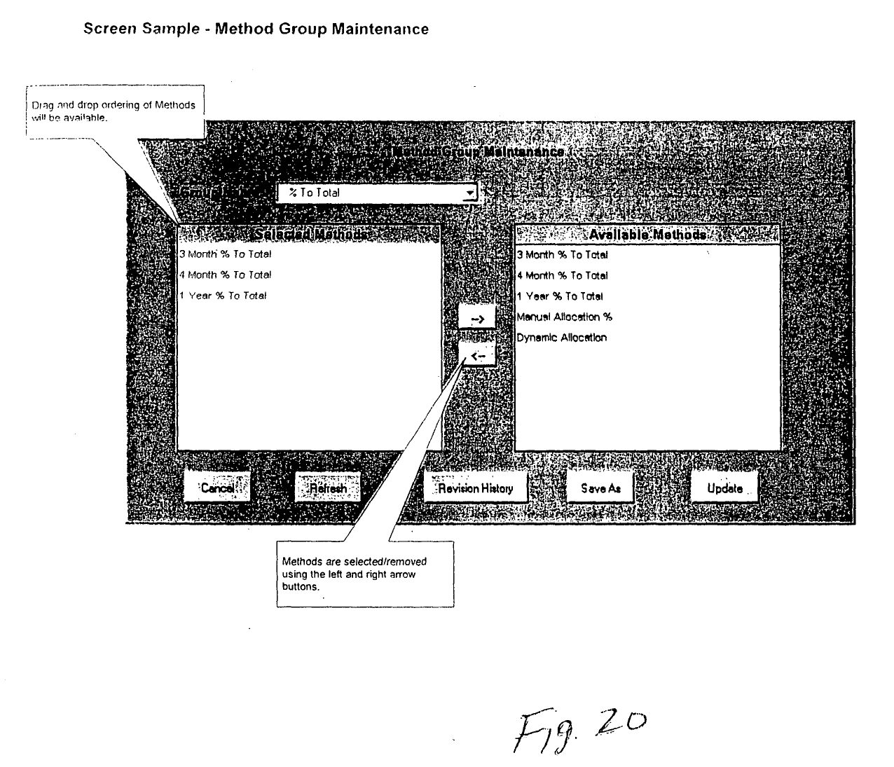

FIG. 20 shows the Method Group Maintenance screen. Method Group Maintenance provides a tool to create subsets of related Methods. Drag and drop ordering of Methods is provided. Methods are selected/removed using the left and right arrow buttons.

It is noted that the above screen shots are exemplary only and that the specific implementation may vary without departing from the scope of the invention.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the scope of the appended claims.

We claim:

1. A system for use by a sales administrator for allocating product, comprising:
an accounts interface for allowing the sales administrator to define accounts for product allocation;
a products interface for allowing the sales administrator to define products for allocation;
an allocation interface that enables the sales administrator to assign an allocation method for each defined product;
a computer program that summarizes analysis statistics by allocation method, time and products;
a statistics interface that displays the summarized analysis statistics and enables the sales administrator to perform a historical analysis of product performance by account; and
a computer program that allocates a launch quantity to each account for a new product launch and allocates product to each account for replenishment of a previously launched product based on the allocation method assigned to the product.

2. The system of claim 1, further including a redistribute procedure that uses product availability measures to redistribute the allocations based on product availability and allocation methods used.

3. The system of claim 1, further including an allocation interface that shows the allocations for a selected product.

4. The system of claim 3, wherein the allocation interface enables the sales administrator to make manual adjustments to the computer generated allocations.

5. The system of claim 1, further including a procedure that loads the allocations into an order processing system.

6. The system of claim 1, wherein the products interface enables products groups to be defined.

7. The system of claim 1, wherein the accounts interface enables account groups to be defined, and the allocation interface enables an account group to be selected for display of the allocation.

8. The system of claim 2, wherein the redistribute procedure takes product advertisement information into account when redistributing allocations.

9. The system of claim 8, further including an interface to an ad planning system which provides the advertisement information to the system.

10. The system of claim 1, wherein the allocations methods are at least one of fixed, variable and dynamic.

11. The system of claim 1, further including a logging function that enables display of revision history for allocations.

12. The system of claim 1, wherein the statistics interface displays historical information for related products for use by the sales administrator in making allocation decisions.
